(19) United States
(12) Patent Application Publication
(10) Pub. No.: US 2018/0174078 A1
(43) Pub. Date: Jun. 21, 2018

(54) Real-Time and On-Demand Scheduling System

(71) Applicant: Mohannad Barakat, Dallas, TX (US)

(72) Inventor: Mohannad Barakat, Dallas, TX (US)

(21) Appl. No.: 15/844,489

(22) Filed: Dec. 15, 2017

Related U.S. Application Data
(60) Provisional application No. 62/436,414, filed on Dec. 19, 2016.

(51) Int. Cl. G06Q 10/02; G06Q 30/06; G06Q 50/30; H04W 4/02

(52) U.S. Cl. CPC G06Q 10/02; H04W 4/025; G06Q 50/30; G06Q 30/0631

(57) ABSTRACT

A real time and on demand vehicle wash scheduling method has the steps of a user providing identification information for a vehicle, the user finding a predetermined service menu, the user requesting a booking to wash a vehicle producing a request, sending the request to the nearest service provider, the service provider accepting or ignoring the booking, the service provider performing the vehicle wash, the user rating the service provider after the wash, and the service provider rating the user after the wash. In an embodiment, a plurality of service providers, wherein the service provider that receives the request is the closest service provider to the vehicle location. The booking may be selected from the group consisting of on-demand booking and membership booking. In some embodiments, the service provider that receives the request is a random service provider. The request may be for a wash time in the future.

### CROSS-REFERENCE TO RELATED APPLICATION(S)

The present application claims priority to U.S. Provisional Patent Application No. 62/436,414 filed on Dec. 19, 2016, entitled “Real-Time and On-Demand Scheduling System” the entire disclosure of which is incorporated by reference herein.

### BACKGROUND

### 1. Field of the Invention

The present invention relates to the field of systems to schedule mobile wash services, and in particular real time and on-demand scheduling of mobile wash services for vehicles.

### 2. Description of Related Art

There is a need for people to clean their vehicles, and in the prior art the vehicle owner would have to drive their vehicle to a wash location in order to have the vehicle washed or wash the vehicle themselves. The people washing the vehicle were selected by the managers of the business, and trust in the business would cause vehicle drivers to have their vehicle washed there. In some cases, vehicle washers are located in car parks and clean the vehicle while owners shop or enjoy walking.

Alternatively, the owner could wash a vehicle in the laneway or garage. This entails spending at least 15 minutes to half an hour out in the driveway to clean the vehicle manually, causing discomfort for an owner. Difficult in the best of weather, self-washing a vehicle is impossible in the winter.

Mobile wash services exist and may be scheduled, such that one or more vehicle washers appear at a location at a particular time. However, washing needs to be coordinated between the parties, and is generally not available at short notice. Further, current technology is costly, wastes excessive water, has limited working hours, is not flexible and available on-demand, disturbs and soils the wash area, and is generally cumbersome.

Therefore, there is a need for a system allowing customers to request interior and exterior vehicle wash services from an approved service provider that uses a wash process. Customers in the same area as a vehicle wash service ought to be able to request wash services and have a variety of near-by service providers available. Alternatively, the wash service provider should have freedom to be located where and at any time he or she desires, such that he or she may be more productive. This allows the service provider to make use of his or her personal time while not providing wash services. A solution has heretofore remained unsatisfied.

### SUMMARY

The system permits customers to request vehicle wash services (exterior, interior or both, in basic and/comprehensive configurations) from anyone who subscribes to be a partner (service provider) with the system. Once service providers go online, customers in their area (a radius is predetermined) will be able to request the service through two options (explained below), therefore, the closest Service Provider will automatically receive a wash request through the app, he/she can either accept and directly goes to the customer's location to complete the job, or they may reject it. In an embodiment, the system includes predetermined services; service providers may not offer any services out of the system.

A real time and on demand vehicle wash scheduling method has the steps of a user providing identification information for a vehicle, the user finding a predetermined service menu, the user requesting a booking to wash a vehicle producing a request, the system sending the request to the nearest service provider, the service provider accepting or ignoring the booking, the service provider gets directions to the vehicle location, the service provider performing the vehicle wash, the user rating the service provider after the wash, and the service provider rating the user after the wash.

In an embodiment, a plurality of service providers, wherein the service provider that receives the request is the closest service provider to the vehicle location. The booking may be selected from the group consisting of on-demand booking and membership booking. In some embodiments, the service provider that receives the request is a random service provider.

The request may be for a real time and on-demand wash or for a scheduled wash time in the future, and may have the additional step of the user setting payment information, wherein the user may pay per wash or have a membership. The system may also have the additional step of continually monitoring the vehicle engine control unit for unusual vehicle behavior.

The system may have the step of timing out a request if the service provider does not accept the request within a predetermined time, and providing the request to the next nearest service provider

In an embodiment, the method has the step of communicating with a VIN scanner to determine the make and model of the vehicle, and to match ownership of the vehicle with the user. It may have the step of interfacing with a vehicle cleanliness scanner to determine the cleanliness of the vehicle before and after the vehicle wash, and the method may also have the step of interfacing with RFID tags within the wash tools to ensure tools are not left within the vehicle after the wash.

Finally, the system may apply to a clean of the interior of a vehicle as well.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart showing the service provider interface and interactions of the system, according to an embodiment;

FIG. 2 is a flowchart showing the customer interface and interactions of the system, according to an embodiment;

FIG. 3, is a flowchart showing a simplified process of the system operating to interact with users in an embodiment;

FIG. 4, is a flowchart showing a simplified process of a customer, or user or consumer operating to interact with the system in an embodiment;

FIG. 5, is a flowchart showing a simplified process of a service provider operating to interact with the system in an embodiment;

FIG. 6 is a diagram showing relationships within the system in an embodiment;

FIG. 7 is a diagram showing several computer systems that are coupled together through a network which may be used with the system in an embodiment;

FIG. 8 shows one example of a personal device or computer which may be used with the network of FIG. 7 and the system in an embodiment.

### DETAILED DESCRIPTION

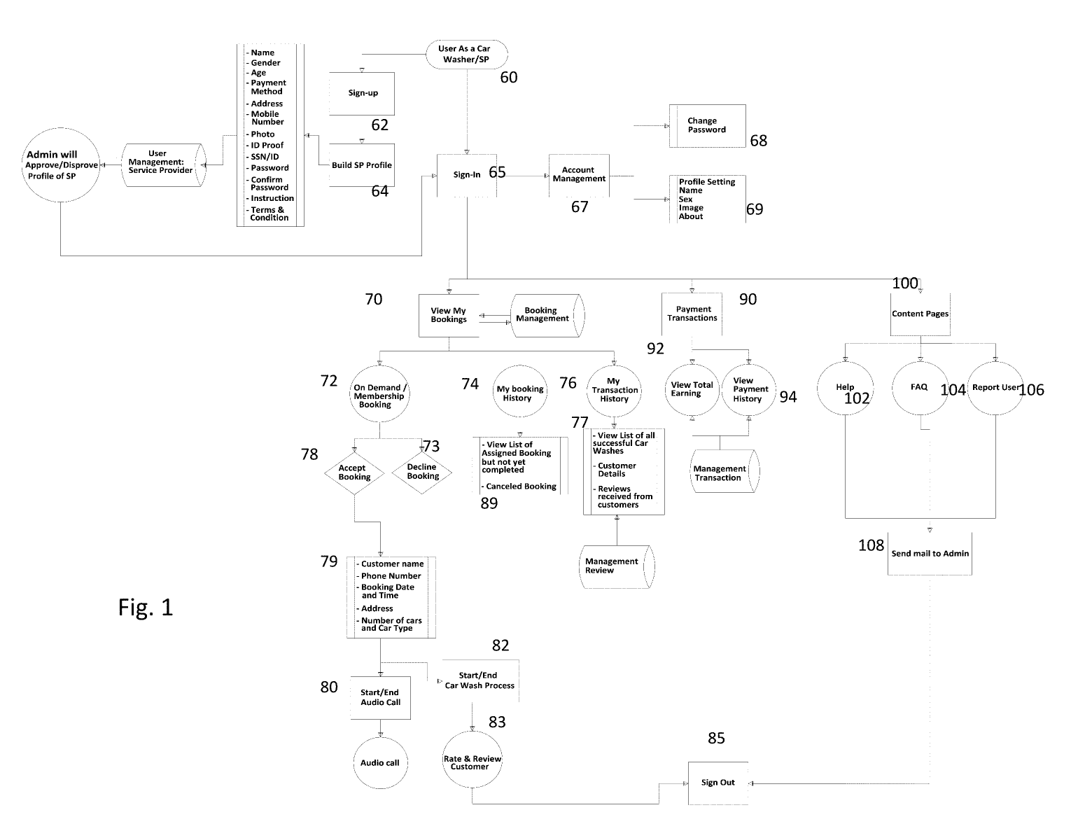

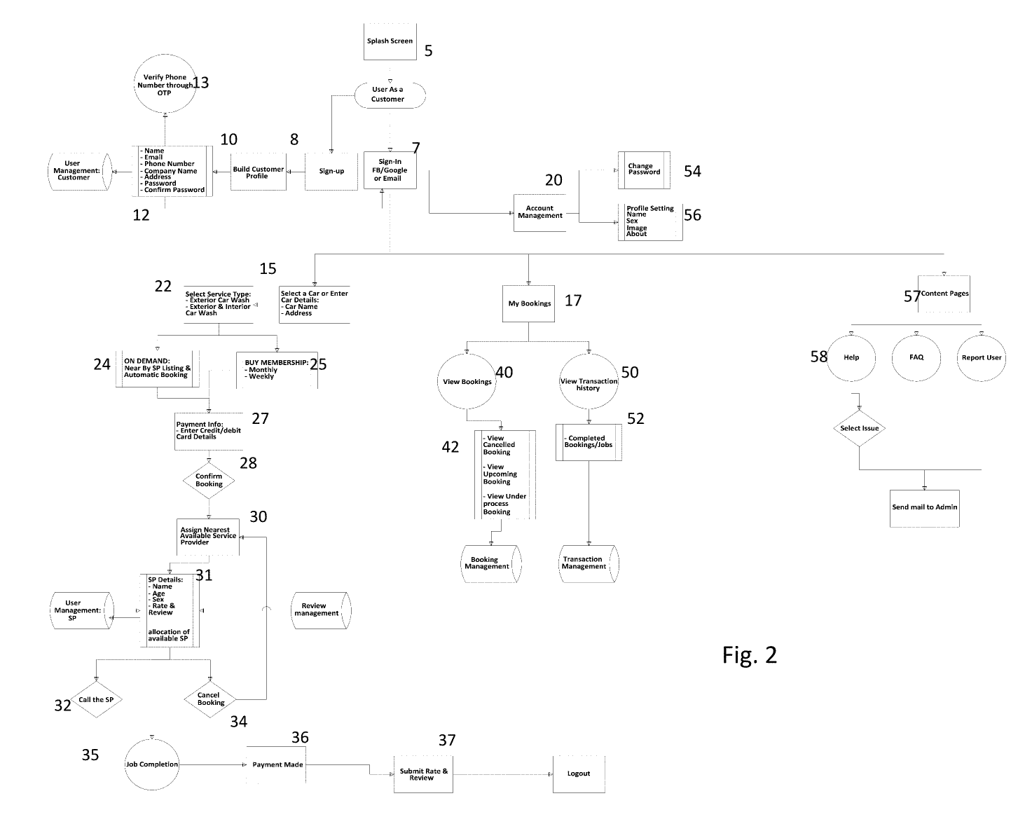

Preferred embodiments of the present invention and their advantages may be understood by referring to FIGS. 1 and 2, wherein like reference numerals refer to like elements.

With reference to FIG. 1, in an embodiment, the Service Provider downloads the system (in an embodiment a smartphone app) and register using normal sign up or a social account such as Facebook, they would sign-in with a username/email and password, and fill in required information such as name, ID photo, Social Security, photo, payment method(s) and other information. A service radius may also be provided, wherein the Service Provider can deliver the service within the terms of the system. Service Providers' information is automatically sent to the insurance company. The insurance company collects the information in case of an accident or damage during the service or related to the service. The service provider optionally must be approved by the system as partners. When they are available, the service provider can mark that the Service Provider is available online, and consequently the service provider is made available to customers, so potential customers can see them on map and the service provider may start receiving vehicle wash requests.

With reference to FIG. 2, customers, such as individuals or business, should download the app and register using an individual sign up, or information from a social account such as Facebook, or Google Plus. The customer would sign-in with a username/email and password, and fill in required information, when they are ready, they can start requesting the vehicle wash service by checking for an online service provider within a set radius on the map.

The system may provide the following criteria to customers to select from: i) a scheduled vehicle wash duty call, or ii) an on-demand request. When a customer opens the app, they may check if there is any available/online service provider on map, and then request for a wash from that, or any, provider under certain constraints, such as time or cost.

A scheduled request may comprise a monthly membership plan with, for example, 1, 2 or 4 washes per month, and the app then requests the customer to determine some days and time frames, for example two days (3) of the week and hourly time frames (not exceeding a range of 2 hours) as a preference for when services are to be conducted, and the system will consequently will reflect and schedule selected dates/time frames automatically for the forthcoming weeks of the customer's subscription.

A vehicle wash implementation may comprise an exterior wash (body, glass, tires and rims cleaning), an interior wash (vacuuming, glass cleaning and wiping), or both an exterior & interior wash. Other types and combinations are permitted of course, and may be advertised or provided as options through the app to the customers.

Based on the customer's above-mentioned selections and provided vehicles information, such as sedan, compact, sport-utility vehicle (SUV), the app will calculate Services fees, and allow the customer to review and confirm payment information prior to final request. The app may also determine the actual make and model of the vehicle to look up special considerations, for example suggested paint or interior treatments.

As soon as the customer finalizes his request, and based on his duty call selections the app will either immediately send a request (in case of on demand) to an “online” service provider closest to the customer. Then the service provider may either accept, not respond or accept but then cancel. In both cases of not responding or accepting but then canceling for whatever reason, the app may automatically keep sending the request to the next closest service provider until the request gets accepted by a service provider within a certain radius only.

The system may also facilitate scheduling of washes, and may send a request (in case of a monthly membership) to an “online” service provider closest to the customer one hour prior to the scheduled request. Then the service provider may either accept, not respond or accept and then cancel. In case of accepting, the app should directly send a reminder to the customer that he/she has a wash service after an estimated time so he/she makes sure to open the vehicle to the service provider (in case of the customer requested an interior wash, for example). However, when the system reminds customers, it may give them two options to select from, namely accepting (to confirm their vehicle is in the entered location) or declining (to let us know that the vehicle is not in the entered location) the current wash only (which does not cancel the subscription) so the service provider does not waste time and go to the location only to miss the customer, and also not to charge the customer for a missed appointment. In both cases of not responding or accepting but canceling for whatever reason, the app will automatically keep sending the request to the next closest service provider within the first given day and time frame only until the request gets accepted by a service provider, however, if there was no service provider available at that first day and time frame within a certain radius, the system may automatically postpone the service to the second given day and time frame within the same week.

In the case of customers cancelling their request, they may re-request thereafter. Once the request is accepted, the provider will head to the customer's vehicle location, through a provided navigation system. Service providers should be able to view the requesting customer's rating average before the service provider accepts the request to help him/her decide either to accept it or not. Also, once the request is accepted, the customer should be able to view the service provider's rating average to help him decide either to continue or cancel.

The system may then provide the customer with an Estimated Time of Arrival, thereafter the app will send a notification to the customer notifying them that the Service provider is close, a reminder to remove their valuables from the vehicle and notification when Service Provider arrives. In the case of the Interior vehicle wash, for example, the customer should be available on location to provide access to the vehicle, and the system will also provide an option for the service provider to cancel the customer request in the case the customer is not available within a predetermined time or does not respond to notifications, and accordingly a list of cancelation reason will be shown to provider.

Once arriving at the customer's vehicle, the service provider may slide a button to indicate initiating the wash service, accordingly and automatically the app will display the provider in a different color indicating that he is occupied, show other customers an estimated time needed to be available for the next request, and notify the customer that the service provider is washing his/her vehicle with the same estimated time (per the vehicle and wash types) for the vehicle to be ready.

After the service is completed, the service provider may slide a button again indicating completion of services, wherein the system may automatically do the following: i) notifying the customer that his/her vehicle is ready and ii) request to rate vehicle wash satisfaction and service provider, and since the customer might not be available on spot to review and rate as soon as the vehicle is washed, a second request may be sent a pre-determined time later, after around 4-6 hours for example. Customers should never be able to view individual and average service providers' ratings feedback for them. In an embodiment, the camera control appears after completion of the wash so that the service provider can take a photo of the vehicle for communication to the customer. The photo may be further shared on social networks by the customer or the app.

The system also requests the service provider to rate the customer. In an embodiment service providers should never be able to view individual customer's ratings feedback for them; however, service providers can view their overall rating average at any time). The system notifies the service provider to run a checkup to ensure that no belonging or tools are left behind. The system may schedule the next wash for the following week, or other predetermined time in the future, in the case of memberships.

The system will transfer payment from customers, and sends them the receipt via Email. Payments may be deducted automatically from the customer account in which all transactions are handled electronically through the app via PayPal™ and Credit Card supported payment gateways only (cashless transactions).

In an exemplary embodiment of the present disclosure and with reference to FIG. 2, the customers download the app and register for services to their personal device by creating their own sign-in or using the sign-in of a social network or other website. In step 5 the user receives the splash screen. In step 7 the user signs in to the system or signs up in step 8, if this is the first time using the system. The user may set a profile in step 10 to record their preferred location, the preferred location and time for having their vehicle washed, and the specifics of their vehicle, to assist the service provider to locate their vehicle within a crowded parking garage, for example. In another embodiment, the user requests on-demand services wherein only the location is transmitted in the service request. In setting up the account, payment information is required, such as credit card or bank data, name, email, login, password, address and optionally account information for a third party pay system like Paypal, and this information is stored to a database in step 12 and may be verified with third party databases in step 13. Once the user creates a login through the sign-up procedure in step 8, they may sign in in step 7.

Once signed in, the user may i) select a car to maintain in step 15 (which also provides the opportunity to enter a new car), ii) manage his/her bookings in step 17, or manage his or her own account in step 20. In maintaining the car in step 15, the car name and address is stored in the car profile, and the user may select a type of wash in step 22, being an exterior wash or exterior/interior wash.

The app may be in contact with a cloud server that may receive paint specifications for a particular vehicle type and model year. Maintenance and cleaning history may be used to set reminders on dates relating to vehicle services that have been scheduled. The profile also includes customer information and one or more payment methods. In another embodiment, the system retrieves the year, make, and model information based on the user inputting the vehicle identification number (“VIN”).

Although the type of wash may be customizable by the customer or by the service provider, a pre-populated group of wash services may be found in the app, namely (1) exterior wash, including soap and water, a waterless wash using wax and wash spray, and various add-ons such as cleaning the glass, tires, rims, or other parts and (2) an interior cleaning, including vacuuming, glass cleaning and wiping down smooth surfaces. The customer may desire both exterior and interior wash services.

The customer may then request a wash from nearby service providers, in the form of (1) an on-demand request in step 24, wherein they open the app and check if there are any available/online service providers on map nearby, and then request a wash or (2) a scheduled request in step 25, wherein a monthly membership plan with one or more washes per month under a service plan, wherein the customer is required to provide a pre-determined time slots to permit scheduling by the Service Provider.

In an embodiment of the present disclosure, Service Providers will be displayed for customers on a map in two different colors. A first color indicates service providers that are online and available to receive requests and a second color denotes occupied service provider. A customer is able to see service provider's rating directly after the service provider accepts the customer's request. Optionally, the customer may view a history for previous vehicle washes, a help section, promotions for free or discounted washes, along with contact information for the service provider to request specific information about the services and provide suggestions. In another embodiment, a menu of services is provided to the customer for each service provider.

The system determines the fees payable, any applicable discounts, and charges the customer's payment method. The app then provides a final confirmation page on which the customer can accept his or her selection, or edit further. Once the customer finalizes his or her choice, the request is sent to the cloud server. After the service request is accepted by a service provider, the app then shows the customer the location of the service provider in real time as the service provider approaches the vehicle, and the customer may also receive information or determine at which stage of the wash or interior cleaning the service provider is. In another embodiment, the app will display an estimated time to completion notification that is sent to the customer according to his/her vehicle and wash types and alerts the customer as to when the service will be completed.

Once the booking details are taken, customers add their payment information in step 27, however the money is not yet transferred, and the booking is confirmed at step 28. In step 30 the nearest available service provider is assigned, and the customer is apprised of this. In an embodiment, customers cannot select the service provider based on past experiences. Customers submit the request, the app sends it to the nearest service provider, and then the service provider either accepts it or ignores it. In case of accepting, the service provider details will be shown to the customer including his rate. At that point if the customer does not like the rate or the service provider for whatever reason, he/she may cancel the request and can restart the request. In case of the service provider ignoring the request; the app automatically sends the request to the next closest service provider, and so on, until the wash request is accepted. At step 31 the service provider public profile is shown to the customer including current location, list of services, optional upselling opportunities, as well as ratings and reviews received previously, in an embodiment, the ratings are averages only. The service provider profile information is stored in a database, along with the review information.

The customer has options in step 32 to call the service provider to inquire about the services or to make special requests, or to cancel the booking at step 34. In step 35 the job is completed, if not cancelled first, in step 36 the money is transferred, and in step 37 the customer may rate and review the service provider.

In step 17, the customer may manage the bookings, and in an embodiment, the app notifies the customer and the service provider of up-coming scheduled services. Once the user enters the booking management system, they may view bookings in step 40, or may view a transaction history in step 50. The bookings view shows cancelled bookings, upcoming bookings, and bookings in progress at step 42. Each booking contains information to at least identify a vehicle, the time and location of the booking, and the type of wash. Once in the transaction history, at step 52, completed bookings or jobs are shown.

When the user manages the account in step 20, the user may change the password at step 54 or may change profile setting, name, sex, image or other attributes at step 56. In step 57 content pages may be accessed, and in step 58 it may be seen that these may include “Help”, “FAQ”, or “Report User”.

In another exemplary embodiment of the present disclosure, the app sends notifications to the customer. For example, as the service provider departs for the vehicle the customer may be reminded to remove all valuables from the vehicle if an interior cleaning is provided, as well as to leave the vehicle unlocked or provide a secure key location. The customer may be required to respond to the notification to ensure the vehicle's location is accurate for the cleaning and in the appropriate state (e.g., unlocked, out of the elements, etc.), and if the system does not receive a response, the request may be cancelled. In another embodiment, the app graphically displays the Service Provider's location on a map to allow the user to monitor his or her location.

With reference to FIG. 1, in another exemplary embodiment the service provider downloads the app and registers with the service using a username and password. The service provider signs up and creates a profile in step 62. From step 64, the service provider profile may include name, gender, age, payment information, address, phone number, photo, national identification number, government issued identification, password, other identification details as well as terms and conditions for the service provider's services. The service provider information is stored in a database, and optionally is sent to an admin for approval. In step 65, the user signs in and in step 67 enters account management wherein the user may change a password at step 68 or change profile information such as name, sex, image, about etc. in step 69.

In step 70 the user enters a subsystem for viewing bookings, which stored and accessed by database, and provides paths to on demand/membership booking at step 72, a booking history at step 74 and my transaction history at step 76. In on demand booking, at step 72, the user may accept or may decline a booking at step 73. When accepting a booking in step 78, at step 79 the service provider receives the customer name phone number, booking date and time, address and number of cars and car type. In step 80, the service provider may start or end an audio call, and in step 82 the user starts and completes the car wash process at the allotted time and place, and in step 83 the service provider rates and reviews the customer, and optionally signs out at step 85. If transaction history at step 76 is selected, the service provider may view a list of successful or unsuccessful car washes, along with various associated details.

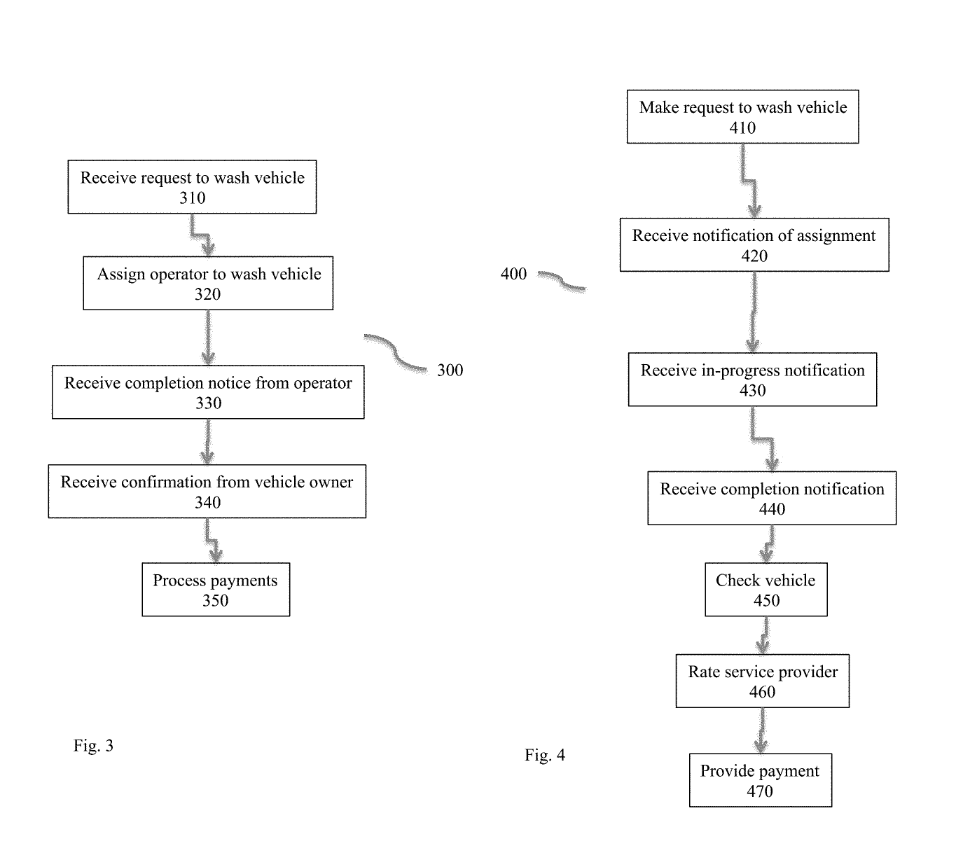

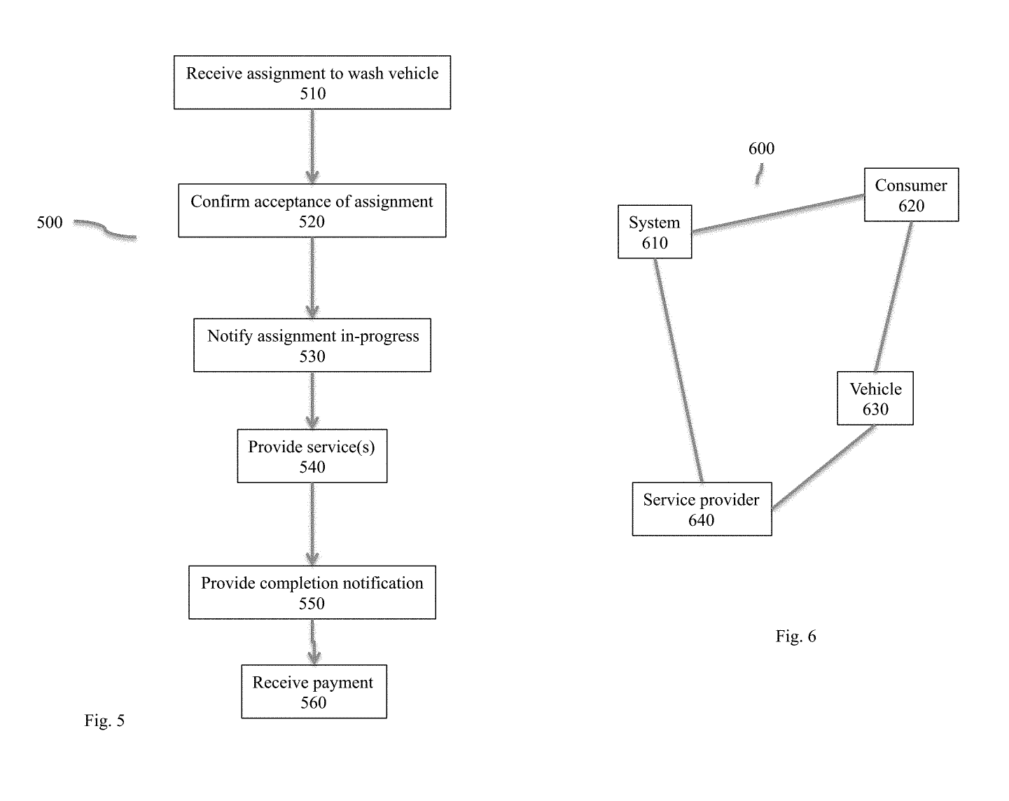

Turning to FIG. 3, a simplified process of the system operating to interact with users in an embodiment is provided. Process 300 is provided as a series of steps or modules, which can be implemented in series or parallel form, or may be implemented in a combination of series and parallel sub-processes, for example. Moreover, process 300 provides an example order of operations but the order may vary according to the situations encountered in various embodiments. These aspects of process 300 apply to the processes of FIGS. 1 and 2, and to the processes of FIGS. 4 and 5 as well. Process 300 refers to washing a vehicle, but this may encompass a number of services beyond simply washing a vehicle.

Process 300 initiates with a request to wash a vehicle at module 310. At module 320, an operator or service provider is assigned to wash the vehicle. This may involve choices based on consumer/customer request, geographic location of the service provider, availability of the service provider, or a bid by a service provider, for example.

At module 330, the process receives a completion notice from the service provider, indicating the vehicle has been washed, or other services have been performed. At module 340, confirmation from the vehicle owner is received by the process, indicating the vehicle owner acknowledges completion of the process and/or receipt of the services. This may also be accomplished through a default process in cases where no response is received either confirming or disputing service. At module 350, payment is processed for the services in question. Note that this does not attempt to deal with dispute resolution issues or variations which may occur in the processes. Rather, it provides for the typical process the system experiences for a specific process resulting in the cleaning of a vehicle after a consumer requests cleaning and as a service provider provides the services requested.

Note that the requests involved in modules such as module 310 or module 410, for example, may be generated specifically by a user responsive to interaction at the time of the request. However, such requests may also be generated in a subscription format, where a request is automatically generated as part of the process. Moreover, the request may be an on-demand or request for essentially instantaneous service, with the understanding that such service may actually be delayed by considerations such as availability of service providers and physical travel times. For requests based on a subscription service, the request may be generated by the system responsive to the existence of the subscription, and may be generated at a predetermined time, such as one hour before the subscribed time for service, for example.

The perspectives of the consumer and the service provider also help in understanding the nature of the processes and system. In FIG. 4, a simplified process of a customer, or user or consumer operating to interact with the system in an embodiment is provided. Process 400 is illustrated initiating with a request from the consumer to wash a vehicle at module 410. At module 420, the consumer receives notification that an operator or service provider has been assigned to provide the services. At module 430, the consumer receives a notification that the services are being provided, and at module 440, the consumer receives a notification that the services have been completed.

The consumer then is expected to check the vehicle at module 450 to determine the services have been provided. This may be a simple visual observation from a distance or may involve a more thorough review of the vehicle. It may also involve reviewing a photo provided by the service provider, for example. At module 460, the consumer provides a rating of the service provider, and thereby confirms completion of the services and provides that notification to the system. Note the system may presume confirmation after a certain amount of time, for example, or in situations where a response is not forthcoming. At module 470, payment is provided, such as through the system. Note that the payment processing of module 470 may be distributed through the process 400, such as requiring payment in advance in conjunction with module 410 and processing payment to a service provider upon some form of confirmation of completion at module 460, for example.

In FIG. 5, a simplified process of a service provider operating to interact with the system in an embodiment is provided. Thus, the perspective of the service provider interacting with the system may also be understood. At module 510, a service provider receives a request to wash a vehicle, with various details about requested time, location and services. At module 520, the service providers confirms acceptance of the assignment, which may otherwise be presumed or may be involved in a bidding process, for example. At module 530, the service provider notifies the system that the services are being provided responsive to the assignment. This may also be inferred from information provided by a device used by the service provider to track progress, such as a mobile phone or similar device, for example. At module 540, the service provider provides the services in question, or the services assigned to the service provider. At module 550, the service provider provides a completion notification, and may include a photo of the vehicle to show that the services have been provided. The service provider may also receive a reminder to check for any items left in the vehicle during the process of providing services. At module 560, the service provider receives payment through the system for providing the services.

Turning to FIG. 6, relationships within the system are illustrated. System 610 interacts with consumer 620 to receive requests for washing a vehicle, either on-demand or scheduled, and payments related to the process. System 610 also sends and receives notifications, confirmations and feedback. Consumer 620 owns, operates or otherwise handles washing of vehicle 630, for example, and thus has a need to arrange for the services requested. Service provider 640 receives requests/assignments and confirmations from system 610 in relation to vehicles such as vehicle 630. Thus, service provider 640 may travel to vehicle 630, wash it or otherwise provide services related to the vehicle 630, and confirm the nature of the assignment, services provided, and eventually receive payment from system 610. System or network 600 is made up of system 610, consumers 620, vehicles 630 and service providers 640, and provides for the interaction between the various entities and vehicles.

The app displays the service provider's geographic location and services provided to the customer whenever the service provider is online. The app uploads the service provider's profile to a cloud-based database where the system provider may review and approve the application. The profile information may also be checked against a security database for felonies or the actual identity of the service provider such that dishonest individuals may be excluded from the service provider roster. Once the service provider initiates the app, his or her GPS location is uploaded to the cloud, such that the location may be shared with the customers and ranked for a match with customers by proximity or other criteria. Information related to proper washing of vehicle.

In an embodiment, the server matches the customer's request to a service provider. The server matches the nearest service provider to the customer. The server sends a notice to the nearest service provider that must be accepted or ignored by the service provider. If the service provider ignores the request for service, the server sends a notice to the next closest service provider. The server sends notifications to each service provider in the order of distance from the customer until the request is accepted by a service provider.

In another exemplary embodiment of the present disclosure, once the customer requests service, the information is provided to the service providers who may accept the request. In the case of an on-demand request, the server matches the closest service providers with the request. The service provider may accept or not respond to the request. If the service provider accepts, the request is allocated to them and removed from selection by other service providers. If the closest service provider does not respond to the request, the next closest service providers are notified of the request and are given an option to accept the request. The distance to the service provider widens at each iteration where the request is ignored. In another embodiment, each iteration sends the request to a pre-determined number of service providers (such as three) at a time, to facilitate quicker responses from available service providers. In another embodiment of the present disclosure, each iteration sends the request to only one service provider at a time. In another embodiment, service requests that are accepted by a service provider and subsequently canceled are autonomously sent to the next nearest service provider by the server. In another embodiment, service requests that are terminated by customer must be reinitiated by the customer. In another embodiment, the app displays the estimated time to completion of a service provider with whom that customer has an impending service request.

If the service provider selects the booking history path at step 74, in step 89 the service provider can view a list of assigned bookings and cancelled bookings. If the service provider selects the transaction history path at step 76, in step 77 he/she is provided with a list of successful car washes, customer details, and reviews received, and these are contained in a review management database.

In step 90, the service provider may select the payment transactions tab. If the user would like to view total earnings of the current week, then he can do so in step 92, and alternatively payment history may be viewed at step 94, and data for both of these options is stored in the transaction management database. The service provider may also enter the content pages path at step 100 and is presented with options such as help (step 102) which brings up a help screen, FAQ (step 104) which brings about a list of frequently asked questions and their answers, and reporting a user (step 106), which reports a user to the admin. This mail is sent to the admin in step 108 via the email processing system, and thereafter the user may sign out in step 85.

If the service request is accepted by a service provider, the request is assigned to the service provider and a notification is sent to the customer that the request has been accepted and providing an estimated time for arrival. Additionally, the server may calculate and send the customer the estimated time to complete the wash based on the customer's vehicle and services requested. If the customer requested an interior cleaning, the customer may unlock the vehicle or provide a key location to the cleaner. If no service provider is available for that day at that time, the service request is postponed to the second pre-selected day that week, according the schedule determined by the customer. In such a case, the service provider does not mark the service as complete.

The service provider travels to the customer's vehicle's location once a service provider accepts the request. In another embodiment, the app provides directions to the service provider wherein the directions are provided using GPS signals and a user interface such as GOOGLE MAPS™. The server reports the service provider's location to the customer's app to inform the customer of the service provider's progress in real-time.

In another exemplary embodiment, the service provider may provide updates on stages of the wash to provide an indication to the customer as the wash proceeds. The app may deliver an estimated time notification that is sent to the customer according to the customer's vehicle and service requested. In another embodiment, the app notifies the customer when the service provider is near or arrives at the customer's vehicle. Once the service is complete, the request is marked as such by the service provider and the payment is forwarded to the service provider's designated banking account. The app autonomously relays information to the customer that the wash is complete. If the wash is not complete, the request is not marked as complete and the payment is not transferred. The customer is requested to review the wash service once the service is marked as completed. In another embodiment, the customer is reminded again, a period later (perhaps 6 hours), such that the wash quality may be assessed while the vehicle still is clean. In another embodiment, the service provider is reminded to not leave tools or equipment at the wash site, and an itemized list may be provided to help account for all the equipment. In another exemplary embodiment, the app provides the ability to cancel the service to the service provider on a predetermined basis including the customer not being available within five minutes of the scheduled service, whether the customer is unresponsive to phone calls or text messages, or whether the customer's vehicle is locked or otherwise inaccessible. In another embodiment, the app collects the fee calculated from the customer.

In one embodiment, the customers may not view the service provider's reviews for customers. In another embodiment, the customers may not view any previous review relating to any service provider. In an embodiment, customers may view the service providers' average rate after requesting the service to help them either continue or cancel the service. In another embodiment, service providers may view average ratings for their services by their customers in general so they can improve themselves.

Customers may rate the service provider and the services rendered based on overall experience including attitude, quality, how the customer was treated, whether the service provider canceled the request an excessive number of times, and whether the service provider was prompt and timely available. Customers may also rate the service provider according to a similar set of criteria. The server generates an average from previous customer ratings and the current customer may view the average after sending a request and being accepted by a service provider. In another embodiment of the present disclosure, the service provider may prevent service requests from customers that do not meet a predetermined customer-rating threshold.

In another exemplary embodiment of the present disclosure, the system may provide the ability for the customer to invite contact such as friend or other interested customers to apply. Either party may send an invitation for a service provider to join the system. The app may also keep a list of found items, which may be stored in the app, in the event that a customer finds any forgotten belonging of the service provider.

Customers may enter their vehicle information such as VIN (wherein VIN is optional), make, model, plate number, color and vehicle picture, preferably into their profile, to have the accurate price calculation. In addition to the vehicle address and parking floor in case they have a garage with different floors should be provided. Customers may be able to add multiple vehicles.

In an embodiment, the system features “found items” button in case customer finds any forgotten belonging to the service provider in his vehicle, and a camera icon to take a photo for the item to be sent to the admin, or to be automatically routed to the service provider that last provided a service for the customer.

In an embodiment, service providers may be shown for customers on map in two different colors, for example, a first color is used to show a service provider that is free/available online provider to receive requests, and a second color is used to show that the online provider is occupied, with another wash service, for example.

The system may have an order button, for service providers to order wash supplies, and an instructions button that have wash instructions and videos of how to wash a vehicle for service providers' reference. Once the service provider applies to be a partner and fills in all required information and attests that the provided information is correct, the partner should add their payment information to deduct a background check fee in case false information is provided in which case the cost of background check is passed back to the partner. The system may automatically notify the admin to review and confirm prior to sending the partner's information via email to the background check department requesting a background check on him/her. Further, the system may automatically send this information via email to the background check department, and also, to email his/her background check report to the system administrator. The app may interface with a retina scanner or facial recognition in association with identity verification and a background check.

Once accepted, the system may do the following: 1) send service provider's information to the payroll service provider and the Insurance Company to add them for payroll purposes; and 2) notify service providers that he/she was approved and should read instructions and then may order supplies through the system. However, the “Order Supplies” button should not be activated before the user checks a box certifying that they have read and understood all instructions and legal documents. In the “Order Supplies” button, the system should provide a full-package of supplies only for first time service providers since it will have all the requirements for the wash service. For subsequent orders, the system should provide them with a supplies list to select whatever they need.

In an embodiment, customers may not be able to request either “on-demand” OR “monthly membership” vehicle wash in the case where no service provider is online within the given radius. However, owners and authorized people controlling accounts are should be able to track all online service providers regardless of how far they are.

In an embodiment, in case the service provider could not by any chance attend to a customer's request in the first preferred day and time frame, the service provider will not be able to check the vehicle wash service as completed, and consequently the app will reschedule services for the next preferred day and time frame within the same week and so on.

A short time limit, such as five minutes' time limit will be given as a timer count down on both customer's and service provider's devices until the request gets accepted. Otherwise, the app will re send the request to the next closest service provider.

In the case where no service provider was available at all the whole week at the scheduled location, the wash will be postponed automatically to the next first given day and time frame within the next week, the customer should be aware at the time of requesting that no obligation is applicable on the system provider and no fee would be charged. The app should notify customers in these cases that no one is available to provide the service.

In an embodiment, the system should provide customers with a “Get Fare Review” button option to submit in case they encountered a technical issue that results an incorrect fare. There will be a refund in some cases such as: a) if service provider did not show up for any reason; b) if service provider started but did not complete the job for any reason; c) if service provider had some missing parts of the service; and d) in case of customers requested and then did not show up or canceled the request for whatever reason after they passed the limited time for cancelation, automatically, they will be charged a fixed fee through the App. The same result would occur if the user provides a wrong address, however if they did this before they passed the limited time, nothing will be charged. The service provider should have options to select from the system when these cases happen, such as “Do not charge Customer”, “Customer no show”, “Customer requested cancel” and “Wrong address shown”.

In order for customers to have the option to request multiple vehicles wash, they should first have all their vehicles information added to their profiles. Therefore, when service providers receive a request for multiple washes, they should know how many washes are requested to help them decide either to accept or ignore. Also, the system should give only customers who have more than one vehicle information saved in their accounts the option of selecting multiple washes and number of vehicles that need to be washed.

In some embodiments, a GPS device is placed in all registered vehicles to be integrated to the app, to provide the exact vehicle coordinates through 2D/3D map including floor numbers. This device will be automatically activated between starting and completing the request only. When a service provider indicates he or she is in service, the device automatically activates, and when the service provider indicates he or she is out of service, it deactivates.

A VIN scanner may be used or interfaced with, to verify all needed vehicle's information/history. The VIN scanner may be a separate device but more commonly will consist of a database that contains VINs and vehicle configuration information, as well as vehicle accident/theft history. Using the VIN information, the system may recover stolen vehicles which use the service.

In an embodiment, vehicle cleanness scanners determine the cleanness percentage of the vehicle. In an embodiment, a high-quality scanner that determines the dust and dirt by scanning the vehicle throughout, it comparing the current vehicle status with its original status when manufactured. The system may integrate with a spray meter, which determines the thickness of the paint, so that the service providers are informed as to the remedies that they may use for cosmetic detailing of scratches, etc. The system may also read the detergents mixing ratio with water, and determines if it meets certain standards of washing quality. Such a solution would involve an ongoing monitor for the fluid in a hose, to determine the component mixture (by weight, surface tension, or spectrography) of the fluid passing the sensor(s), and the information on the mixture is sent to the app.

In an embodiment, RFID tags mounted on the tools may interface with the app to make sure no tools are left on the work site. So long as a tool is within proximity of the service provider device, no alarm will sound but once the tools are separated, without authorization, from the mobile device an alarm or notification sounds to remind the service provider that the tool is being left behind.

In an embodiment, the system is connected to a sprayer that would record the quantity of liquids used and to confirm that the service providers have started work. Similarly, using steam tools and equipment to clean the vehicle facilitates monitoring the amount of cleaning supplies used.

In an embodiment, dust detector may be used to detect dirty spots in the vehicle. The dust detector may consist of a camera that analyzes inconsistency in the image, indicating dirt on the paint. The dust detector may automatically request a wash through the app, without waiting for the customer to do the request.

In an embodiment, the service provider may also provide oil changes, inflate tires and provide tire replacement services. Customers may also be able to lock/unlock their vehicles for service provides though the app, so long as their vehicle is in communication with the system.

When the vehicle is integrated to the app, the app directly indicates any suspicious move by the service provider, such as, steering wheel movement, or theft of the vehicle such as loading it onto a flatbed, and this may be determined by accessing the car's ECU, which senses and stores actions of various components of the car. In the alternative, a high sensitivity sound system in the app may be used, to determine unusual sounds relating to the vehicle.

In an embodiment, customers will be able to view their clean vehicle photo prior to request the service through filters that app provides to the actual vehicle photo. Each filter shows the vehicle cleanness according to the wash type the customer selects.

In an embodiment, the app is connected to an automatic washing device attached to the roof of a vehicle, that may have a number of extension brushes, spray nozzles and other cleaning peripherals. The automatic washing device may be external or built into the vehicle roof. The app may also be connected to a self-driving system, wherein the vehicle drives itself to the wash station to be cleaned.

User devices and service provider devices can include one or more of a portable computing device such as a smartphone, wearable computing device (e.g., watch or fitness band), Google Glass-type device, tablet, electronic media player, laptop computer, desktop computer, etc. A server can include a single network server device, a multiprocessor network server device, a distributed computing system, a cloud computing system or the like.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for computerized wash service request systems having enhanced safety features.

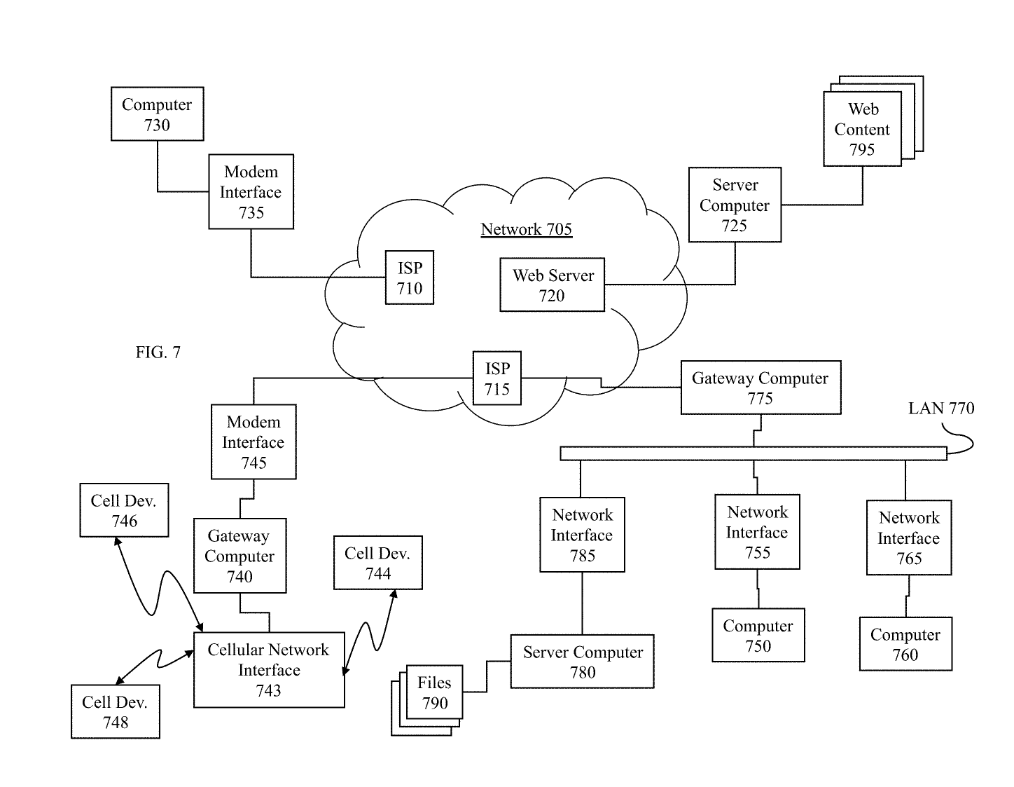

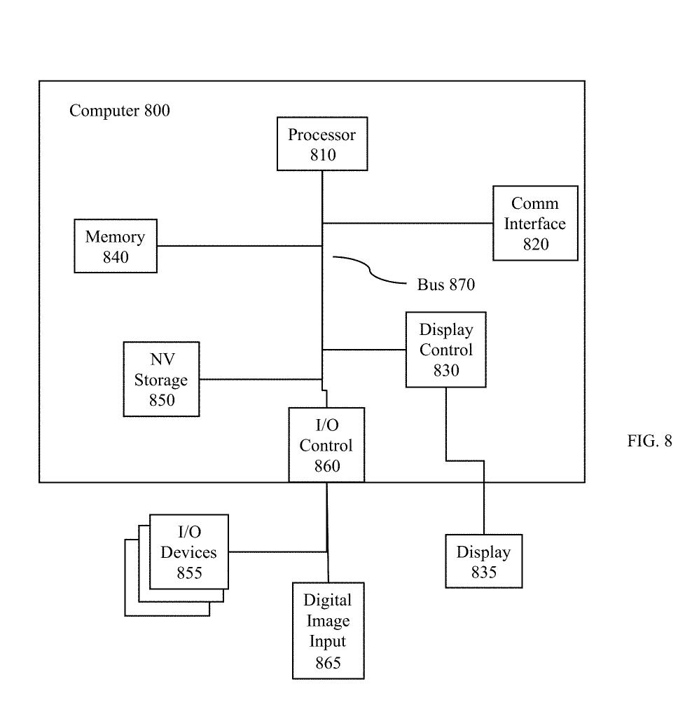

The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example.

Cellular network interface 743 is representative of wireless networking in general. In various embodiments, such an interface may also be implemented as a wireless interface such as a Bluetooth interface, IEEE 802.11 interface, or some other form of wireless network. Similarly, devices such as devices 744, 746 and 748 may be implemented to communicate via the Bluetooth or 802.11 protocols, for example. Other dedicated wireless networks may also be implemented in a similar fashion.

Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 800 of FIG. 8 may also be used to implement other devices such as a personal computer, network computer, or other similar systems. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium-based microprocessor or other microprocessor, a Texas Instruments digital signal processor, or some combination of the various types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal. Alternatively, a physical medium may be used as a machine-readable medium or computer-readable medium.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Apple OS® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCEÆ or PalmÆ operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A real time and on demand vehicle wash scheduling method, comprising:
a. a user providing identification information for a vehicle;
b. the user finding a predetermined service menu;
c. the user requesting a booking to wash a vehicle producing a request;
d. sending the request to the nearest service provider;
e. the service provider accepting or ignoring the booking;
f. the service provider gets directions to the vehicle location;
g. the service provider performing the vehicle wash;
h. the user rating the service provider after the wash; and
i. the service provider rating the user after the wash.

2. The vehicle wash scheduling method of claim 1, comprising a plurality of service providers, wherein the service provider that receives the request is the closest service provider to the vehicle location.

3. The vehicle wash scheduling method of claim 1, wherein the booking is selected from the group consisting of on-demand booking and membership booking.

4. The vehicle wash scheduling method of claim 1, comprising a plurality of service providers, wherein the service provider that receives the request is a random service provider.

5. The vehicle wash scheduling method of claim 1, wherein the request is for a wash time in the future.

6. The vehicle wash scheduling method of claim 3, wherein the booking is for a real time and on demand wash or for a scheduled wash time in the future.

7. The vehicle wash scheduling service of claim 1, further comprising the user setting payment information, wherein the user may pay per on-demand wash or have a membership.

8. The vehicle wash scheduling service of claim 1, further comprising continually monitoring the vehicle engine control unit for unusual vehicle behavior.

9. The vehicle wash scheduling service of claim 1, further comprising timing out a request if the service provider does not accept the request within a predetermined time, and providing the request to the next nearest service provider.

10. The vehicle wash scheduling service of claim 1, further comprising communicating with a VIN scanner to determine the make and model of the vehicle, and to match ownership of the vehicle with the user.

11. The vehicle wash scheduling service of claim 1, further comprising interfacing with a vehicle cleanliness scanner to determine the cleanliness of the vehicle before and after the vehicle wash.

12. The vehicle wash scheduling service of claim 1, further comprising interfacing with RFID tags within the wash tools to ensure tools are not left within the vehicle after the wash.

13. The vehicle wash scheduling service of claim 1, further comprising cleaning an interior of the vehicle.

14. A method, comprising:
a. receiving a user identification information for a vehicle in real time and on demand vehicle wash scheduling;
b. receiving a user selection from a predetermined service menu;
c. receiving a the user request for a booking to wash a vehicle;
d. producing a request to wash the vehicle responsive to the user request for a booking;
e. sending the request to the nearest service provider;
f. receiving a response from the service provider accepting or ignoring the booking;
g. providing the service provider directions to the vehicle location;
h. receiving confirmation from the service provider that the service provider performed the vehicle wash;
i. providing confirmation of the service provider to the user;
j. receiving a user rating of the service provider after the wash; and
k. receiving a service provider rating of the user after the wash.
